(19) United States
(12) Patent Application Publication
(10) Pub. No.: US 2018/0323822 A1
(43) Pub. Date: Nov. 8, 2018

(54) FREQUENCY MODULATED SPREAD SPECTRUM MODULATION METHOD, MODULATOR, AND FREQUENCY MODULATED SPREAD SPECTRUM DEMODULATION METHOD, DEMODULATOR

(71) Applicant: HANGZHOU VANGO COMMUNICATIONS, INC., Hangzhou (CN)

(72) Inventor: Ching-Kae TZOU, Hangzhou (CN)

(73) Assignee: HANGZHOU VANGO COMMUNICATIONS, INC., Hangzhou (CN)

(21) Appl. No.: 15/795,257

(22) Filed: Oct. 27, 2017

(30) Foreign Application Priority Data
May 8, 2017 (CN) 201710316981.4

(51) Int. Cl. H04B 1/69; H04L 27/12; H04L 27/14

(52) U.S. Cl. CPC H04B 1/69; H04L 27/14; H04L 27/12

(57) ABSTRACT

A frequency modulated spread spectrum modulation method and modulator and a frequency modulated spread spectrum demodulation method and demodulator are provided. The modulation method includes: determining bit information to be transmitted, where the bit information includes one of N bit sequences and N is a positive integer; generating modulation waveforms corresponding to the bit sequences, where different bit sequences in the N bit sequences have a one-to-one correspondence with different modulation waveforms, and the different modulation waveforms have different feature information; and modulating a carrier signal by using the modulation waveform corresponding to the determined bit information to acquire a modulated signal. With the above solution, an amount of information included in the modulation waveform can be increased effectively, thereby being beneficial to increase a data rate in a signal transmission process.

### CROSS REFERENCE TO RELATED APPLICATION

The present application claims the priority to Chinese Patent Application No. 201710316981.4, titled “FREQUENCY MODULATED SPREAD SPECTRUM MODULATION METHOD, MODULATOR, AND FREQUENCY MODULATED SPREAD SPECTRUM DEMODULATION METHOD, DEMODULATOR”, filed on May 8, 2017 with the State Intellectual Property Office of the PRC, which is incorporated herein by reference in its entirety.

### FIELD

The present disclosure relates to the technical field of communications, and particularly to a frequency modulated spread spectrum modulation method, a frequency modulated spread spectrum modulator, a frequency modulated spread spectrum demodulation method and a frequency modulated spread spectrum demodulator.

### BACKGROUND

The frequency modulation technology is a conventional technical means in the data communication field. With the technology, it is convenient to transmit a signal in channels, thereby being beneficial to reduce energy loss in a signal transmission process.

However, in the conventional frequency modulation technology, an amount of information actually carried in a modulation waveform each time is limited, and increase of the data rate in a signal transmission process is limited, thereby consuming long transmission time.

It may be seen that, how to increase the data rate in the signal transmission process is a problem to be further solved presently.

### SUMMARY

In view of above, an object of the present disclosure is to provide a frequency modulated spread spectrum modulation method, a frequency modulated spread spectrum modulator, and a frequency modulated spread spectrum demodulation method and a frequency modulated spread spectrum demodulator, so that an amount of information included in modulation waveforms can be increased effectively, thereby being beneficial to increase a data rate in a signal transmission process. The specific solutions are as follows.

A frequency modulated spread spectrum modulation method is disclosed, which includes:

determining bit information to be transmitted, where the bit information includes one of N bit sequences and N is a positive integer;

generating modulation waveforms corresponding to the bit sequences, where different bit sequences in the N bit sequences have a one-to-one correspondence with different modulation waveforms, and the different modulation waveforms have different feature information; and

modulating a carrier signal by using the modulation waveform corresponding to the determined bit information to acquire a modulated signal.

Optionally, the modulation waveforms may have different shapes.

Optionally, the modulation waveforms may have different shapes in a same symbol period.

Optionally, the feature information may include at least one of a phase, an amplitude and a frequency.

A frequency modulated spread spectrum modulator is further disclosed in the present disclosure, which includes:

a bit information determination module configured to determine bit information to be transmitted, where the bit information includes one of N bit sequences and N is a positive integer;

a waveform generator configured to generate modulation waveforms corresponding to the bit sequences, where different bit sequences in the N bit sequences have a one-to-one correspondence with different modulation waveforms, and the different modulation waveforms have different feature information; and

a signal modulation module configured to modulate a carrier signal by using the modulation waveform corresponding to the determined bit information, to acquire a modulated signal.

Optionally, the modulation waveforms generated by the waveform generator may have different shapes.

Optionally, the modulation waveforms generated by the waveform generator may have different shapes in a same symbol period.

Optionally, the feature information may include at least one of a phase, an amplitude and a frequency.

A frequency modulated spread spectrum demodulation method is further disclosed in the present disclosure, which includes:

receiving the modulated signal transmitted via the frequency modulated spread spectrum modulator disclosed above;

demodulating the modulated signal to acquire feature information related to the modulation waveforms; and

determining bit information corresponding to the acquired feature information.

A frequency modulated spread spectrum demodulator is further disclosed in the present disclosure, which includes:

a signal receiving module configured to receive the modulated signal transmitted via the frequency modulated spread spectrum modulator disclosed above;

a signal demodulating module configured to demodulate the modulated signal to acquire feature information related to the modulation waveforms; and

an information determining module configured to determine bit information corresponding to the acquired feature information.

In the present disclosure, the frequency modulated spread spectrum modulation method includes: determining bit information to be transmitted, where the bit information includes one of N bit sequences and N is a positive integer; generating modulation waveforms corresponding to the bit sequences, where different bit sequences in the N bit sequences have a one-to-one correspondence with different modulation waveforms, and the different modulation waveforms have different feature information; and modulating a carrier signal by using the modulation waveform corresponding to the determined bit information to acquire a modulated signal.

It may be seen that, in the present disclosure, before the modulation waveform is generated, the bit information to be transmitted including a bit sequence is determined firstly, and a modulation waveform corresponding to the determined bit sequence is generated. The different bit sequences in the N bit sequences have a one-to-one correspondence with different modulation waveforms, and the different modulation waveforms have different feature information. In this case, the bit information including a bit sequence is embedded in the acquired modulation waveform, therefore the bit sequence in one modulation waveform can be restored successfully subsequently based on feature differences of the modulation waveforms. It follows that, according to the present disclosure, an amount of information included in the modulation waveform can be increased effectively, thereby being beneficial to increase a data rate in a signal transmission process.

### BRIEF DESCRIPTION OF THE DRAWINGS

The drawings to be used in the description of the embodiments of the present disclosure or the conventional technology are described briefly as follows, so that the technical solutions according to the embodiments or according to the conventional technology become clearer. It is apparent that the drawings in the following description only illustrate embodiments of the present disclosure. For those skilled in the art, other drawings may be obtained according to these drawings without any creative work.

FIG. 1 is a flow chart of a frequency modulated spread spectrum modulation method according to an embodiment of the present disclosure;

FIG. 2 is a schematic diagram illustrating a correspondence between bit sequences and modulation waveforms according to an embodiment of the present disclosure;

FIG. 3 is a schematic diagram illustrating another correspondence between bit sequences and modulation waveforms according to an embodiment of the present disclosure;

FIG. 4 is a schematic diagram illustrating different modulation waveforms defined in a symbol period according to an embodiment of the present disclosure;

FIG. 5 is a schematic structural diagram of a frequency modulated spread spectrum modulator according to an embodiment of the present disclosure;

FIG. 6 is a flow chart of a frequency modulated spread spectrum demodulation method according to an embodiment of the present disclosure; and

FIG. 7 is a schematic structural diagram of a frequency modulated spread spectrum demodulator according to an embodiment of the present disclosure;

### DETAILED DESCRIPTION

The technical solutions according to the embodiments of the present disclosure are described clearly and completely in conjunction with the drawings in the embodiments of the present disclosure hereinafter. It is apparent that the described embodiments are only a few rather than all of the embodiments of the present disclosure. Any other embodiments obtained based on the embodiments of the present disclosure by those skilled in the art without any creative work fall within the scope of protection of the present disclosure.

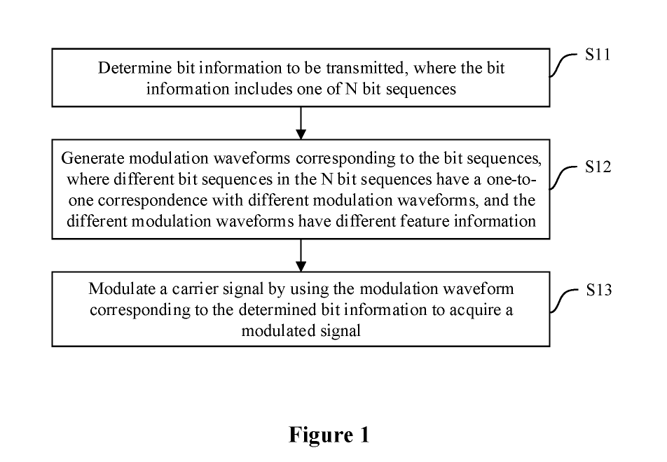

A frequency modulated spread spectrum modulation method is disclosed according to an embodiment of the present disclosure. Referring to FIG. 1, the method includes steps S11 to S13 in the following.

In step S11, bit information to be transmitted is determined. The bit information includes one of N bit sequences, and N is a positive integer.

In step S12, modulation waveforms corresponding to the bit sequences are generated. Different bit sequences in the N bit sequences have a one-to-one correspondence with different modulation waveforms, and the different modulation waveforms have different feature information.

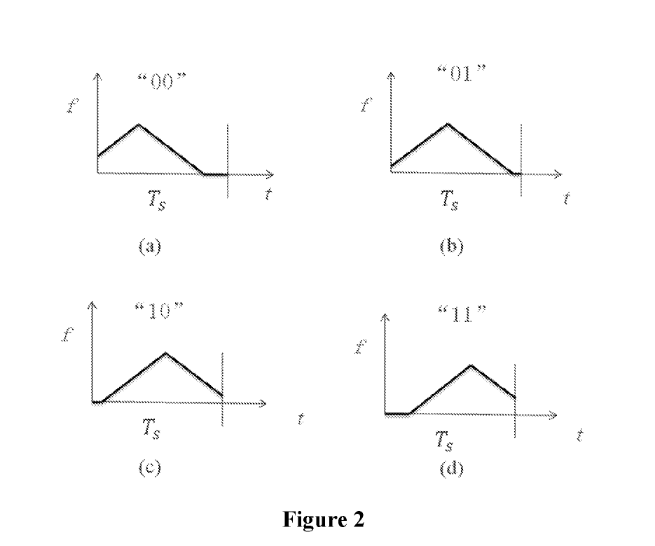

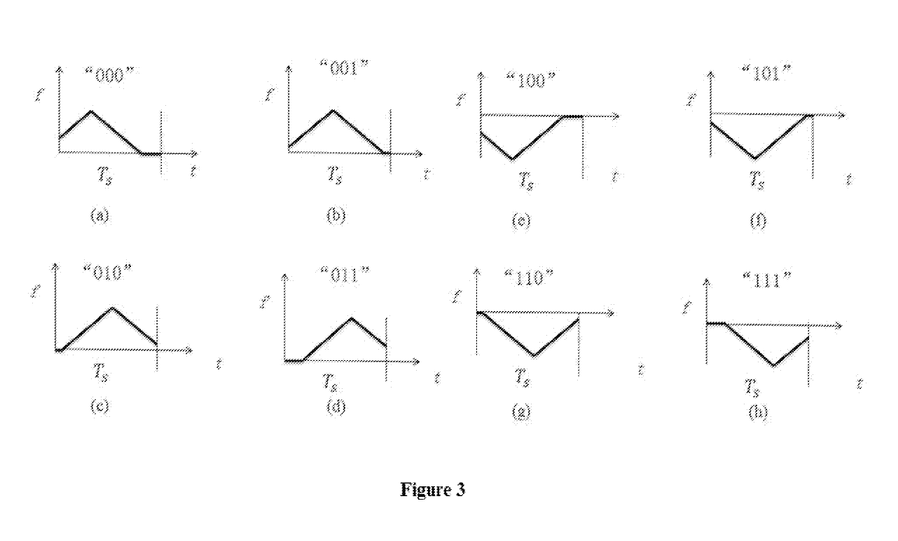

Reference is made to FIG. 2, four different bit sequences “00”, “01”, “10” and “11” correspond to four different modulation waveforms respectively, where each bit sequence is consisted of two bits. For example, reference is made to FIG. 3, eight different bit sequences “000”, “001”, “010”, “011”, “100”, “101”, “110” and “111” correspond to eight different modulation waveforms respectively, where each bit sequence is consisted of three bits.

In the embodiment, the feature information may include but not limited to a phase and/or an amplitude and/or a frequency. For example, the different modulation waveforms have different phases, so that a bit sequence corresponding to a certain modulation waveform can be subsequently determined based on a phase of the modulation waveform.

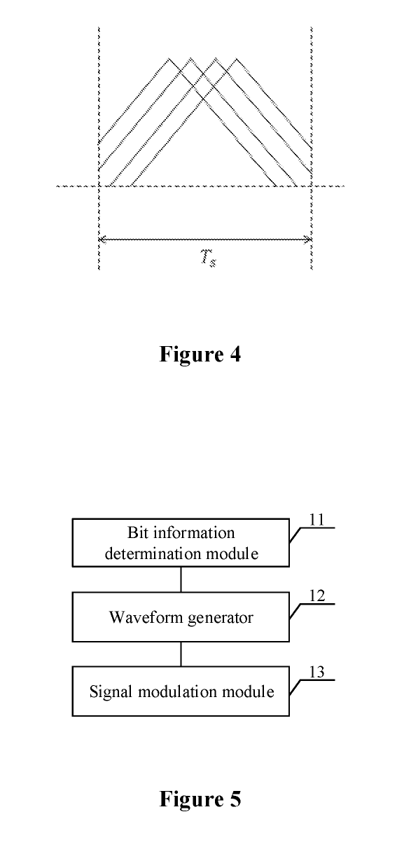

In the embodiment, the different modulation waveforms have different shapes. Specifically, the modulation waveforms corresponding to different bit sequences have different shapes in a same symbol period. Reference is made to FIG. 4, which illustrates four different modulation waveforms defined in a symbol period T.

In step S13, a carrier signal is modulated by using the modulation waveform corresponding to the determined bit information, to acquire a modulated signal.

It should be further noted that, based on the frequency modulated spread spectrum modulation method disclosed in the embodiment, a dual mode modulation method may be formed by combining a Gauss Frequency Shift Keying (GFSK)/Gaussian Filtered Minimum Shift Keying (GMSK) frequency modulation method or a Frequency-shift keying (FSK)/Minimum Shift Keying (MSK) frequency modulation method in the conventional technology, which may be applicable to an Internet of Things (IoT) technology for low power and long distance communication.

It may be seen that, with the modulation method according to the embodiment of the present disclosure, before the modulation waveform is generated, the bit information to be transmitted including a bit sequence is determined firstly, and a modulation waveform corresponding to the determined bit sequence is generated. The different bit sequences in the N bit sequences have a cone-to-one correspondence with different modulation waveforms, and the different modulation waveforms have different feature information. In this case, the bit information including a bit sequence is embedded in the acquired modulation waveform, therefore the bit sequence in one modulation waveform can be restored successfully subsequently based on feature differences of the modulation waveforms. It follows that, according to the embodiment of the present disclosure, an amount of information included in the modulation waveform can be increased effectively, thereby being beneficial to increase a data rate in a signal transmission process.

Accordingly, a frequency modulated spread spectrum modulator is further disclosed according to an embodiment of the present disclosure. Referring to FIG. 5, the frequency modulated spread spectrum modulator includes a bit information determination module 11, a waveform generator 12 and a signal modulation module 13.

The bit information determination module 11 is configured to determine bit information to be transmitted. The bit information includes one of N bit sequences, and N is a positive integer.

The waveform generator 12 is configured to generate a modulation waveform corresponding to the bit sequence determined by the bit information determination module 11. Different bit sequences in the N bit sequences have a one-to-one correspondence with different modulation waveforms, and the different modulation waveforms have different feature information.

The signal modulation module 13 is configured to modulate a carrier signal by using the modulation waveform corresponding to the determined bit information to acquire a modulated signal.

Specifically, the feature information may include but not limited to a phase and/or an amplitude and/or a frequency. For example, the different modulation waveforms have different phases, so that a bit sequence corresponding to a certain modulation waveform can be determined based on a phase of the modulation waveform subsequently.

In the embodiment, different modulation waveforms generated by the waveform generator 12 have different shapes. Specifically, the modulation waveforms generated by the waveform generator 12 have different shapes in a same symbol period.

It should be further noted that, based on the frequency modulated spread spectrum modulator disclosed in the embodiment, a dual mode modulator may be formed by combining a GFSK/GMSK frequency modulator or an FSK/MSK frequency modulator in the conventional technology, which may be applicable to the IoT technology for low power and long distance communication.

It may be seen that, with the modulator according to the embodiment of the present disclosure, before the modulation waveform is generated, the bit information to be transmitted including a bit sequence is determined firstly, and a modulation waveform corresponding to the determined bit sequence is generated. The different bit sequences in the N bit sequences have a one-to-one correspondence with different modulation waveforms, and the different modulation waveforms have different feature information. In this case, the bit information including a bit sequence is embedded in the acquired modulation waveform, therefore the bit sequence in one modulation waveform can be restored successfully subsequently based on feature differences of the modulation waveforms. It follows that, according to the embodiment of the present disclosure, an amount of information included in the modulation waveform can be increased effectively, thereby being beneficial to increase a data rate in a signal transmission process.

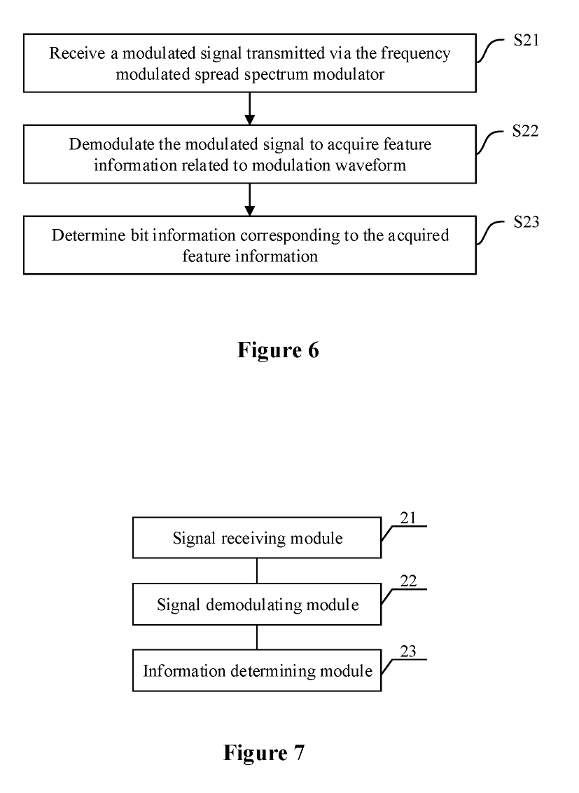

A frequency modulated spread spectrum demodulation method is further disclosed according to an embodiment of the present disclosure. Referring to FIG. 6, the method includes steps S21 to S23 in the following.

In step S21, a modulated signal transmitted via the frequency modulated spread spectrum modulator is received.

In step S22, the modulated signal is demodulated to acquire feature information related to the modulation waveforms.

In step S23, bit information corresponding to the acquired feature information is determined.

The frequency modulated spread spectrum modulator is the frequency modulated spread spectrum modulator disclosed in the above embodiments. For a specific structure of the frequency modulated spread spectrum modulator, one may refer to corresponding contents disclosed in the above embodiments, which is not repeated here.

With the frequency modulated spread spectrum modulator in the embodiment of the present disclosure, an amount of information included in the modulation waveform can be increased effectively, thereby being beneficial to increase a data rate in a signal transmission process.

Accordingly, a frequency modulated spread spectrum demodulator is further disclosed according to an embodiment of the present disclosure. Referring to FIG. 7, the frequency modulated spread spectrum demodulator includes: a signal receiving module 21, a signal demodulating module 22 and an information determining module 23.

The signal receiving module 21 is configured to receive a modulated signal transmitted via the frequency modulated spread spectrum modulator.

The signal demodulating module 22 is configured to demodulate the modulated signal to acquire feature information related to modulation waveforms.

The information determining module 23 is configured to determine bit information corresponding to the acquired feature information.

The frequency modulated spread spectrum modulator is the frequency modulated spread spectrum modulator disclosed in the above embodiments. For a specific structure of the frequency modulated spread spectrum modulator, one may refer to corresponding contents disclosed in the above embodiments, which is not repeated here.

With the frequency modulated spread spectrum modulator in the embodiment of the present disclosure, an amount of information included in the modulation waveform can be increased effectively, thereby being beneficial to increase a data rate in a signal transmission process.

Finally, it should also be illustrated that a relationship term such as “the first” and “the second” herein is only used to distinguish one entity or operation from another entity or operation, and does not necessarily require or imply that there is an actual relationship or sequence between these entities or operations. Furthermore, terms “include”, “comprise” or any other variations are intended to be non-exclusive, so that a process, a method, an object or a device including a series of factors not only include the factors, but also include other factors not explicitly listed, or also include factors inherent for the process, the method, the object or the device. Without more limitation, a factor defined by a sentence “include one . . . ” does not exclude a case that there is also another same factor in the process, the method, the object or the device including the described factors.

The frequency modulated spread spectrum modulation method, the frequency modulated spread spectrum modulator, the frequency modulated spread spectrum demodulation method and the frequency modulated spread spectrum demodulator provided according to the present disclosure are introduced in detail above. The principles and the embodiments of the present disclosure are clarified herein by specific examples, and the above embodiments are illustrated to assist understanding the method of the present disclosure and a core concept thereof. Meanwhile, for those skilled in the art, the specific embodiments and the application scope can be altered according to the concept of the present disclosure. Therefore, the content of the specification should not be understood as limiting to the present disclosure.

1. A frequency modulated spread spectrum modulation method, comprising:
determining bit information to be transmitted, wherein the bit information comprises one of N bit sequences and N is a positive integer;
generating modulation waveforms corresponding to the bit sequences, wherein different bit sequences in the N bit sequences have a one-to-one correspondence with different modulation waveforms, and the different modulation waveforms have different feature information; and
modulating a carrier signal by using the modulation waveform corresponding to the determined bit information to acquire a modulated signal.

2. The frequency modulated spread spectrum modulation method according to claim 1, wherein the modulation waveforms have different shapes.

3. The frequency modulated spread spectrum modulation method according to claim 2, wherein the modulation waveforms have different shapes in a same symbol period.

4. The frequency modulated spread spectrum modulation method according to claim 1, wherein the feature information comprises at least one of a phase, an amplitude and a frequency.

5. The frequency modulated spread spectrum modulation method according to claim 2, wherein the feature information comprises at least one of a phase, an amplitude and a frequency.

6. The frequency modulated spread spectrum modulation method according to claim 3, wherein the feature information comprises at least one of a phase, an amplitude and a frequency.

7. A frequency modulated spread spectrum modulator, comprising:
a bit information determination module configured to determine bit information to be transmitted, wherein the bit information comprises one of N bit sequences and N is a positive integer;
a waveform generator configured to generate modulation waveforms corresponding to the bit sequences, wherein different bit sequences in the N bit sequences have a one-to-one correspondence with different modulation waveforms, and the different modulation waveforms have different feature information; and
a signal modulation module configured to modulate a carrier signal by using the modulation waveform corresponding to the determined bit information, to acquire a modulated signal.

8. The frequency modulated spread spectrum modulator according to claim 7, wherein the modulation waveforms generated by the waveform generator have different shapes.

9. The frequency modulated spread spectrum modulator according to claim 8, wherein the modulation waveforms generated by the waveform generator have different shapes in a same symbol period.

10. The frequency modulated spread spectrum modulator according to claim 7, wherein the feature information comprises at least one of a phase, an amplitude and a frequency.

11. The frequency modulated spread spectrum modulator according to claim 8, wherein the feature information comprises at least one of a phase, an amplitude and a frequency.

12. The frequency modulated spread spectrum modulator according to claim 9, wherein the feature information comprises at least one of a phase, an amplitude and a frequency.

13. A frequency modulated spread spectrum demodulation method, comprising:
receiving the modulated signal transmitted via the frequency modulated spread spectrum modulator according to claim 7;
demodulating the modulated signal to acquire feature information related to the modulation waveform; and
determining bit information corresponding to the acquired feature information.

14. A frequency modulated spread spectrum demodulator, comprising:
a signal receiving module configured to receive the modulated signal transmitted via the frequency modulated spread spectrum modulator according to claim 7;
a signal demodulating module configured to demodulate the modulated signal to acquire feature information related to the modulation waveform; and
an information determining module configured to determine bit information corresponding to the acquired feature information.
